(19) United States
(12) Patent Application Publication
(10) Pub. No.: US 2003/0126869 A1
(43) Pub. Date: Jul. 10, 2003

(54) Window air conditioner with a fire alarm and smoke exhausting device

(76) Inventor: Wen-Jie Liu, Yung-Kang City (TW)

Correspondence Address: Wen-Jie Liu, P.O. Box 90, Tainan City, 704, TW

(21) Appl. No.: 10/040,468

(22) Filed: Jan. 9, 2002

(51) Int. Cl. G01K 13/00; F25D 23/12

(52) U.S. Cl. 62/129; 62/262

(57) ABSTRACT

A window air conditioner with a fire alarm and smoke-exhausting device includes a body, a front room in said body, a wind-releasing gate and a smoke-exhausting gate provided at a side of the front room, an alarm in the body, a sensor positioned outside and connected to the body. The sensor senses smoke or alteration of temperature to control opening and shutting of the wind-releasing gate and the smoke-exhausting gate and turning-on-and-off of the alarm. If the sensor senses dense smoke or high temperature, a cool air exhauster sucks smoke into the front room and the smoke-exhausting gate, the heat dispersing fan and the heat disperser exhausting smoke out of a room, with the alarm sounding out warning, performing also fire preventing and smoke exhausting to enhance public security

### BACKGROUND OF THE INVENTION

This invention relates to a window air conditioner with a fire alarm and smoke-exhausting device, particularly to one using a common air conditioner additionally provided with a wind-releasing gate and a smoke-exhausting gate fixed at one side of a front room of a body, an alarm fixed in the body, a sensor connected with the body and located outside the body. Then the sensor may sense smoke or alteration in temperature in a room where the window air conditioner is installed to control opening and closeting of the wind-releasing gate and the smoke-exhausting gate and turning on and off of the alarm. Thus the window air conditioner performs fire preventing, smoke exhausting and air conditioning as well, enhancing public security.

As commonly known, high buildings have been increasingly built year by year, and air conditioners have become absolutely necessary to be installed in a high building. And it is prescribed by the fire-preventing law that smoke-exhausting devices must be provided in high buildings. In general, the smoke-exhausting devices of a building are equipped at the same time, but function independently, not related to one another at all.

Besides, a window air conditioner nowadays is only provided with a water inlet, a water outlet, an air conditioning box, a wind inlet and wind outlet, with the air conditioning box provided with a condenser, a motor and a fan. Thus, icy water gets to the condenser through the water inlet and then gets out of the water outlet, and at the same time, the fan is driven by the motor to draw in wind through the wind inlet and the wind gets out of the wind outlet through the condenser, achieving effect of air conditioning.

As can be noted, the conventional way of air conditioning has no functions of smoke exhausting, so in case a fire should happen indoors, one can simply use the smoke-exhausting device alone to remove the smoke out of the room and give out alarm warning, or use a water-spraying device to put out the fire. Under such a condition, a window air conditioner, a smoke-exhausting device and a water-spraying device have to be installed independently in a room, but failing to operate synchronously with quickness in case of a fire and increasing trouble in maintenance.

### SUMMARY OF THE INVENTION

The objective of the is to offer a window air conditioner with a fire alarm and smoke-exhausting device, which has functions of fire preventing, smoke exhausting and alarm warning.

One feature of the invention is a wind-releasing gate, a smoke-exhausting gate fixed at one side of a front room of a body, an alarm fixed in the body and a sensor connected to the body and located outside the body.

Another feature of the invention is an electric circuit including a power terminal connected to a fuse, a reset switch connected to the fuse, the reset switch connected to a normally-closed contact, a normally-open contact, a motor compulsory switch and a transforming and rectifying circuit, the normally-closed contact connected to a power switch, the power switch connected to a temperature adjusting switch and a motor switch, the temperature switch connected to a normally-closed contact and a compressor, the compressor connected to a start condenser, the normally-open contact connected to a motor switch which may be a strong contact or a weak contact, the motor switch connected to a motor and a start condenser, the normally-closed contact connected to the wind-releasing gate and the smoke-exhausting gate, the normally-open contact and the motor compulsory switch connected to the wind-releasing gate, the smoke-exhausting gate and a first relay, another terminal of the power connected to the compressor, the start condenser, the motor, the wind-releasing gate, the smoke-exhausting gate, another relay, and another terminal of the alarm, and the above circuit connected to the transforming and rectifying circuit to form a parallel circuit. The transforming and rectifying circuit has another terminal connected to a third relay and a sensor.

### BRIEF DESCRIPTION OF DRAWINGS

This invention will be better understood by referring to the accompanying drawings, wherein:

FIG. 1 is a side view of a sensor and an alarm arranged in the present invention;

FIG. 2 is a cross-sectional view of a body with a cool air passageway in the present invention;

FIG. 3 is a diagram of an electric circuit of a window air conditioner with a fire alarm and smoke-exhausting device in the present invention; and,

FIG. 4 is a cross-sectional view of the body with a smoke-exhausting passageway in the present invention.

### DETAILED DESCRIPTION OF THE PREFERRED EMBODIMENT

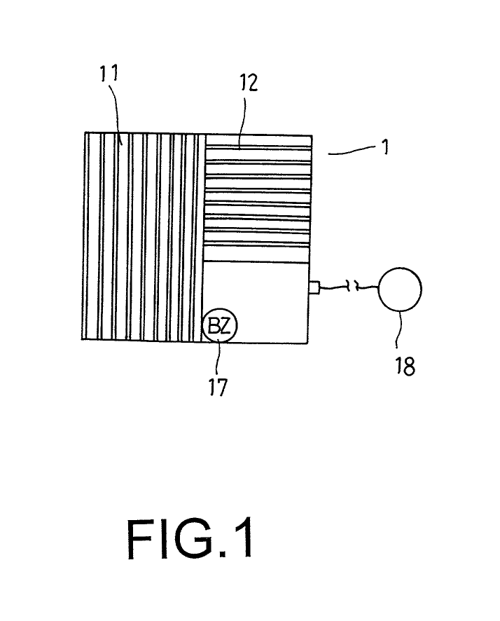

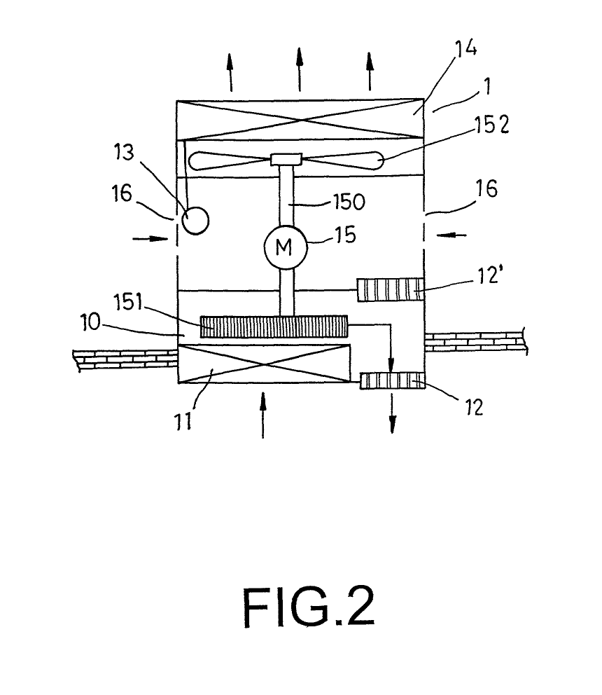

A preferred embodiment of a window air conditioner with a fire alarm and smoke-exhausting device in the present invention as shown FIGS. 1 and 2, includes a body 1, a front room 10 in the body 1, a cool air exhauster 11 provided at one side of the front room 10, a wind-releasing gate 12 and a smoke-exhausting gate 12′ provided at another side of the front room 10, a compressor 13 and a heat disperser 14 fixed in a rear portion of the body 1, a motor 15 with a shaft 150 fixed in an intermediate portion of the body 1, a first fan 151 for circulating coolant fixed in the front room 10, a second fan 152 for dispersing heat fixed at the rear side of the body 1, a ventilating hole 16 respectively provided in two sides of the body 1, an alarm 17 fixed in the body 1, and a sensor fixed outside and connected to the body 1.

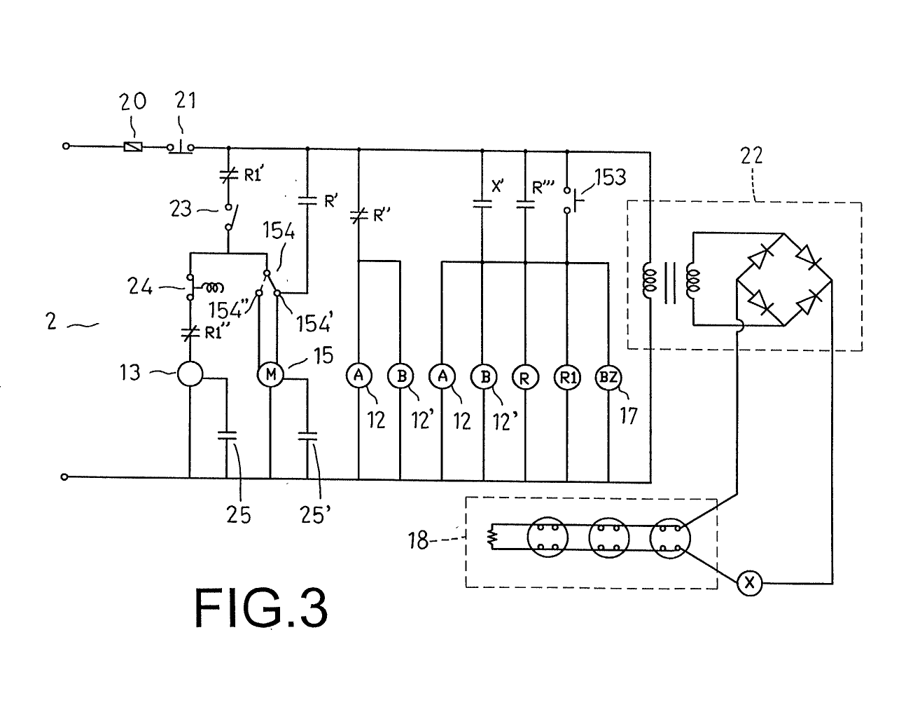

Next, FIG. 3 shows an electric circuit used in the window air conditioner with a fire preventing and smoke-exhausting device. The circuit includes power terminals 2, a fuse 20 connected to one of the power terminal 2, a reset switch 21 connected to the fuse 20 and then connected in parallel to a normally-closed contact R1′, normally-open contacts R′, R′″ and a normally-closed contact R″ of a first relay R, a normally-open contact X′ of a second relay X, a motor compulsory switch 150 and a transforming and rectifying circuit 22. The normally-closed contact R1′ is connected in series to a power switch 23, which is then connected in parallel to a temperature adjusting switch 24 and a motor switch 154. The temperature adjusting switch 154 is then connected in series to a normally closed contact R1″ of a third relay R1 and a compressor 13, which is then connected to a start condenser 25. The normally-open contact R′ of the first relay R is connected in series to the motor switch 154, which may be a strong contact 154′ or a weak contact 154″ and connected in series to the motor 15 and a start condenser 25′.

The normally-closed contact R″ is connected in series to the wind-releasing gate 12 and the smoke-exhausting gate 12′, and the normally-open contacts X′, R′″ and the motor compulsory switch 153 are connected in series to the wind-releasing gate 12, the smoke-exhausting gate 12′, the first and the second relay R, R1 and the alarm 17. The other of the power terminals 2 is connected to the compressor 13, the start condensers 25, 25′, the motor 15, the wind-releasing gate 12, the smoke-exhausting gate 12′, the first and the second relay R, R1 and the other terminal of the alarm 17. Then, the above circuit is connected to the transforming and rectifying circuit to form a parallel circuit. Further, the transforming and rectifying circuit is connected to the third relay X and the sensor 18.

In using the window air conditioner with a fire preventing and smoke-exhausting device in the invention, referring to FIGS. 1-4, the sensor 18 is connected to the body 1 and positioned in a proper location in a room, and the alarm 17 is fixed in a proper location in the body 1 as shown in FIG. 1. When a fire does not happen and the body 1 operates normally, only the power switch 23 is short-circuited to become ON, letting the power terminals 2 supply current to the fuse 20, the reset switch 21, the normally-closed contacts R1′, R″ and the transforming and rectifying circuit 22. Then the current flowing through the normally-closed contact R1′ passes through the power switch 23 to reach the temperature adjusting switch 24 and the motor switch 154. The current flowing through the temperature adjusting switch 24 passes through the normally-closed contact R1″ to reach the compressor 13 and the start condenser 25. The current flowing through the motor switch 154 reaches the motor 15 and the start condenser 25′. The current flowing through the normally-closed contact R″ reaches the wind-releasing gate 12 and the smoke-exhausting gate 12′, and at this moment, the wind-releasing gate 12 is open and the smoke-exhausting gate is shut so that the normally-closed contacts R′, R″ may be short-circuited to become ON.

Further, the current flowing through normally-open contacts R′, X′, R′″ and the motor compulsory switch 153 reaches the transforming and rectifying circuit 22. At this moment, the normally-open contacts R′, X′ R′″ and the motor compulsory switch 153 are all cut off. The current flowing through the transforming and rectifying circuit 22 is transformed into 24V DC, which is then supplied to the third relay X, the sensor 18 and the whole circuit to maintain normal operation.

In addition, the current flowing through the motor switch 154 reaches the motor 15 and the start condenser 25′ to let the motor 15 rotate. At the same time, the motor switch 154 may be the strong contact 154′, permitting the motor 15 rotate with strong speed, and if the motor switch 154 is the weak contact 154″, the motor may rotate with weak speed. Therefore, the shaft 150 of the motor 15 may rotate the first fan 151 and the second fan 152 to suck air in the room into the front room of the body 1, and the first fan 151 sucks in air in the room and cooled by the coolant circulating and blows cooled air out of the wind-releasing gate 12 as shown in FIG. 2, attaining effect of sending cool air.

Moreover, when the temperature in the room reaches the preset one, the temperature-adjusting switch 24 may be automatically cut off, so the compressor 13 may be stopped. But when the temperature in the room does not yet reach the preset one, the temperature-adjusting switch 24 may be automatically turned on, so the compressor 13 will begin to work. If the power switch 23 is turned off, the compressor 13 and motor 15 are all stopped. When the compressor 13 and the motor 15 are in operation or not, the sensor 18 may maintain normal operation.

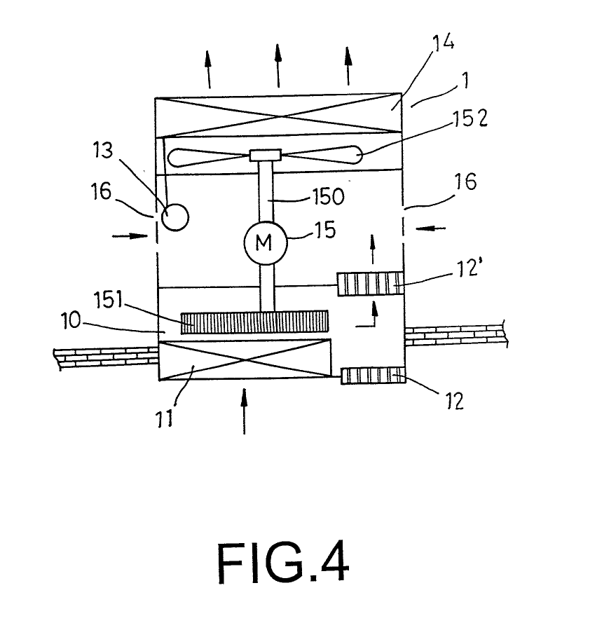

If a fire happens and smoke or high temperature is produced, the sensor 18 can sense the smoke or the high temperature to magnetize the third relay X and short-circuit the normally-open contact X′ to let current flow through the same contact X′ to electrify the wind-releasing gate, the smoke-exhausting gate 12′, the first and the second relay R and R1 and the alarm 17. Then the wind-releasing gate 12 is shut but the smoke-exhausting gate is open, and the current flowing through the first and the second relay R and R1 magnetizes the same relays R, R1 to short-circuit the normally-open contact R′ and cut off the normally-closed contact R1′ so that the compressor 13 and the motor 15 may be stopped. Then the normally-closed contact R″ is cut off and the normally-open contact R′ is connected to the strong contact 154′ and the weak contact 154″ is closed to let the motor switch 154 become the strong contact 154′ so that the motor 15 at once begin to work, rotating with strong speed to exhaust dense smoke. At the same time the alarm sounds out warning and the first fan 151 and the second fan 152 are rotated by the shaft 150 of the motor 15, sucking dense smoke in the front room 10 of the body 1 and then through the wind-exhausting gate 12 and blown out by the second fan 152 and the heat disperser 14, as shown in FIG. 4.

In case that a fire happens but the sensor does not work yet, the motor compulsory switch 153 can be manually pressed to become short-circuited, permitting current flow the same switch 153 and reach the wind-releasing gate 12, the smoke-exhausting gate 12′, the alarm 17, the first and the second relay R and R1. Then the motor rotates, the alarm 17 sounds out warning, and the first and the second relay R, R1 are magnetized to cut off the normally-closed contacts R1′, R″ and short-circuit the normally-open contact R′ so that the motor 15 may work, with the wind-releasing gate 12 shut and the smoke-exhausting gate 12′ open. Thus, the fire alarm and smoke device can be manually handled to perform the fire alarm and smoke-exhausting, should the sensor 18 fail to operate.

The sensor 18 can maintain its operation, even if dense smoke is completely controlled and exhausted out. In case that the sensor should be damaged in a fire, the whole function of the window air conditioner may not affected, and if the reset switch 21 is pressed, the window air conditioner may recover its normal operation.

The window air conditioner with a fire alarm and smoke-exhausting device in the invention has the following advantages, as can be understood from the aforesaid description.

1. It can perform smoke exhausting to enhance public security.

2. It can save expenditure for separately getting a window air conditioner, a fire preventing and smoke-exhausting device, and make use effectively the space of a room.

3. It is easy and convenient to use, maintain and repair.

4. In using it, it can exhaust dense smoke out of a room, alerting passengers-by or neighbors to notice it and report to the police so as to prevent a fire from damaging a house.

While the preferred embodiment of the invention has been described above, it will be recognized and understood that various modifications may be made therein and the appended claims are intended to cover all such modifications that may fall within the spirit and scope of the invention.

1. A window air conditioner with a fire alarm an smoke-exhausting device comprising a body, a front room provided in said body, a cool air exhauster and a first fan for circulating coolant provided at one side of said front room, a compressor, a second fan and a heat disperser orderly provided in a rear portion of an interior of said body, a motor fixed in an intermediate portion of the interior of said body and having a shaft to rotate said first fan and said second fan, and a ventilating hole formed at two sides of said body; and,
characterized by a wind-releasing gate and a smoke-exhausting gate provided at another side of said front room, an alarm provided in said body, a sensor provided outside and connected with said body, said sensor capable to sense dense smoke or high temperature in a room where said window air conditioner is installed, said sensor controlling opening and shutting of said wind-releasing gate and said smoke-exhausting gate and turning on and off said alarm, said cool air exhauster sucking dense smoke into said front room and exhausted out of said smoke-exhausting gate, said second fan and said heat disperser to open air, said alarm at the same sounding out warning, said window air conditioner performing fire preventing and smoke exhausting so as to enhance public security.

2. A window air conditioner with a fire alarm and smoke-exhausting device comprising an electric circuit including power terminals, one of said power terminal connected to a fuse, said fuse connected to a reset switch, said reset switch connected to a normally-closed contact and a normally-open contact, a motor compulsory switch and a transforming and rectifying circuit. said normally-closed contact connected to a power switch, said power switch connected to a temperature adjusting switch and a motor switch, said temperature adjusting switch connected to a normally-closed contact and a compressor, said compressor connected to a start condenser, said normally-open contact connected to said motor switch which may be a strong contact or a weak contact, said motor switch connected to a motor and a start condenser, said normally-closed contact connected to a wind-releasing gate and a smoke-exhausting gate, said normally-open contact and said motor compulsory switch connected to said wind-releasing gate, said smoke-exhausting gate, a relay and an alarm, another one of said power terminals connected to said compressor, said start condenser, said motor, said wind-releasing gate, said smoke-exhausting gate, said relay and another terminal of said alarm, an above circuit connected to said transforming and rectifying circuit to form a parallel circuit, the other terminal of said transforming and rectifying circuit connected to said relay and said sensor.
